(19) United States
(12) Patent Application Publication
(10) Pub. No.: US 2025/0138899 A1
(43) Pub. Date: May 1, 2025

(54) SYSTEMS AND METHODS FOR COMPUTATION OFFLOADING DETERMINATION USING MULTI-MODAL USER INPUT

(71) Applicant: Toyota Motor Engineering & Manufacturing North America, Inc., Plano, TX (US)

(72) Inventors: Daniel Doe, San Jose, CA (US); Dawei Chen, Milpitas, CA (US); Kyungtae Han, Palo Alto, CA (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/883,664

(22) Filed: Sep. 12, 2024

Related U.S. Application Data
(60) Provisional application No. 63/592,959, filed on Oct. 25, 2023.

(51) Int. Cl. G06F 9/50; B60W 30/09; B60W 60/00; G06F 3/01; G06F 3/16; G06Q 30/0241; G06T 19/00; G06V 20/58; G08G 1/16

(52) U.S. Cl. CPC G06F 9/505; B60W 30/09; B60W 60/001; G06F 3/012; G06F 3/013; G06F 3/167; G06Q 30/0241; G06T 19/006; G06V 20/58; G08G 1/167; G06F 2209/509

(57) ABSTRACT

System and method for reducing latency and bandwidth usage in reality devices comprises a reality device and one or more processors. The reality device operably collects behavior data of a user. The one or more processors operable to determine a level of computation offloading to an edge server based on the behavior data, and offload one or more tasks to the edge server based on the level of computation offloading.

This application claims priority to co-pending provisional U.S. Application No. 63/592,959, filed Oct. 25, 2023, which is incorporated herein by reference in its entirety.

### TECHNICAL FIELD

The present specification generally relates to mixed reality, augmented reality, and virtual reality and, more specifically, to mixed reality, augmented reality, and virtual reality using in networking.

### BACKGROUND

Augmented reality (AR) technologies can be integrated into vehicle applications to enhance user interaction and mobility experiences. Remote AR data processing can release local AR computation usage and leverage cloud resources. Therefore, there is a need for a system and method for mixed reality (MR) applications that employ edge-driven object detection for resource optimization to maintain network performance and cost-effectiveness.

### SUMMARY

In one embodiment, a system for reducing latency and bandwidth usage in reality devices includes a reality device and one or more processors. The reality device operably collects behavior data of a user. The one or more processors are operable to determine a level of computation offloading to an edge server based on the behavior data, and offload one or more tasks to the edge server based on the level of computation offloading.

In another embodiment, a method for reducing latency and bandwidth usage in reality devices includes determining a level of computation offloading to an edge server based on behavior data of a user collected by a reality device, and offloading one or more tasks to the edge server based on the level of computation offloading.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an example system for computation offloading determination using multi-modal user input of the present disclosure, according to one or more embodiments shown and described herewith;

FIG. 2 schematically depicts example components of reality devices of the present disclosure, according to one or more embodiments shown and described herein;

FIG. 3 schematically depicts example components of server of the present disclosure, according to one or more embodiments shown and described herein;

FIG. 4 schematically depicts a flowchart for computation offloading determination using multi-modal user input of the present disclosure, according to one or more embodiments shown and described herein;

FIG. 5 depicts a sequence diagram for computation offloading determination using multi-modal user input of the present disclosure, according to one or more embodiments shown and described herein; and

FIG. 6 depicts a flowchart for computation offloading determination using multi-modal user input of the present disclosure, according to one or more embodiments shown and described herein.

### DETAILED DESCRIPTION

Mixed reality (MR) technology, such as augmented reality (AR) or virtual reality (VR), often relies on a combination of on-device and cloud-based processing for tasks like image classification and object recognition. The development of MR-integrated autonomous vehicles and AR technologies is revolutionizing mobility and user interaction experiences. Among the applications of AR technologies, real-time object detection is a desirable feature for MR applications in MR-integrated autonomous vehicles. These object detection tasks may involve context-sensitive driving, such as understanding the user's expectations when regularly looking at scenery, wildlife, or landmarks, providing real-time navigation assistance, and adjusting object detection based on the user's behavior and interactions with others in the vehicle.

Object detection tasks can be performed either locally on user devices or remotely on servers. Due to limitations in processing power, memory, and energy efficiency, processing MR data locally on reality devices may not always be feasible or desirable. High computational requirements can limit MR functionality, drain vehicle resources, and potentially create unsafe situations. Instead, server-based processing can manage computationally intensive tasks like object recognition, scene understanding, and spatial mapping. This remote processing leverages powerful cloud resources and advanced machine learning algorithms, allowing for real-time analysis and access to continually updated models and data.

Remote XR-based tasks need to balance computational requirements and bandwidth usage. Existing methods typically transmit computational tasks to remote devices and servers regardless of the distance between local devices and remote servers, leading to high bandwidth consumption and latency. These methods fail to adapt to data transmission delays caused by transmission distances, resulting in delays and lags that degrade the user experience due to resource over-utilization. Furthermore, current methods focus on local computation capacity and computation intensity, without adaptively considering the user's interaction, attention, and user commands, potentially wasting remote computation resources. Accordingly, there exists a need to selectively offload computation tasks based on the user's input to reduce latency and bandwidth usage.

To address the issues of latency and bandwidth usage, the disclosed system and method for multimodal computation offloading utilize edge computing for optimal resource utilization. By performing computations close to the data source and minimizing the computation results sent from the edge server to the reality devices, the system enables fast decision-making, creates a resource-efficient MR experience, and reduces data transmission, thereby improving overall performance.

The system for performing computation offloading determination using multi-modal user input can determine offloading based on multi-modal user input, such as eye tracking, head movement, and user commands. This allows the system to recognize when the user is actively engaging with navigation data, offloading computation for real-time traffic updates and route calculations, or when the user's attention diverts, effectively providing interactive MR-based assistance and entertainment. For example, when a user's gaze and head movement are steady, indicating immersion in a video or game, the system can offload more computational resources to the AR device for a seamless experience. Conversely, when the user's movements become erratic or a user voice command is issued, computation offloading can be paused to prioritize safety or attend to other user commands. The disclosed system may include a reality device operably collecting behavior data of a user. The system may determine a level of computation offloading to an edge server based on the behavior data, and offload one or more tasks to the edge server based on the level of computation offloading.

Embodiments of systems and methods disclosed herein include a reality device. The reality device may be an AR device, such as an AR headset, a VR device, or a MR device. The camera operably images an environment around a vehicle, such as an automatic vehicle, and captures a set of frames. In the embodiments, the computational tasks that require intense computing resources and thus are undesirable for local processing by the MR device are uploaded to and performed by an edge server. The system thus addresses the latency during object detection using the MR interface and enhances the MR experience of the user, making the MR experience more immersive and responsive.

As disclosed throughout the description, edge computing refers to a distributed computing paradigm that brings computation and data storage closer to the sources of data. Edge computing pushes processing and data storage to a network's edge, closer to end-users and devices instead of relying solely on centralized data centers. An edge server refers to any physical hardware and/or servers that enable edge computing located at the network's edge, closer to data sources or end-users. The edge server may handle data processing, storage, and analysis locally, reducing the need to transmit data to central data centers, such as a cloud server. The edge server may include specialized hardware optimized for specific workloads, such as video processing. The edge computing and the edge server work together to bring computation and data storage to the point of action, reduce latency, and increase bandwidth efficiency.

Various embodiments of the methods and systems for performing computation offloading determination using multi-modal user input are described in more detail herein. Whenever possible, the same reference numerals will be used throughout the drawings to refer to the same or like parts.

As used herein, the singular forms “a,” “an” and “the” include plural referents unless the context clearly dictates otherwise. Thus, for example, reference to “a” component includes aspects having two or more such components unless the context clearly indicates otherwise.

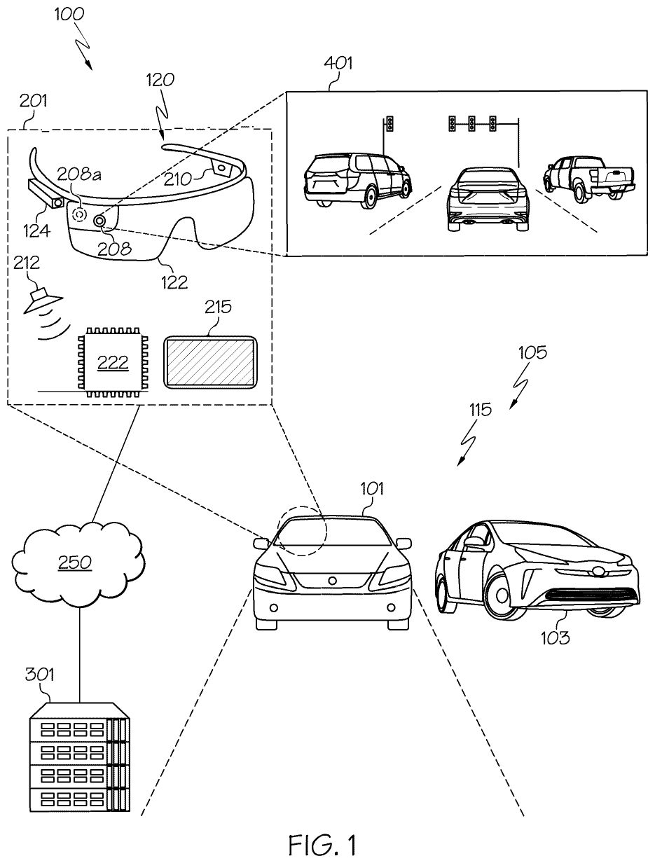

Referring now to Figures, FIG. 1 schematically depicts an example multimodal offloading system 100. The multimodal offloading system 100 may include MR-based devices, such as an AR headset, to facilitate MR operations while driving an ego vehicle 101. These MR operations provide users with an immersive MR experience, encompassing vehicle-related functions like driving, route planning, point-of-interest information, and augmented reality navigation, as well as entertainment options like watching videos, participating in virtual meetings, and engaging in immersive gaming. In embodiments, the computation tasks may be executed either on local devices at the user's end or offloaded to an edge server 301. The multimodal offloading system 100 may determine which computation task to offload based on multi-modal user inputs, such as eye tracking, head movement, and voice commands of the user, and resource allocation for the tasks.

The multimodal offloading system 100 includes components, devices, and subsystems based on MR-related and data-transmission-based technologies for information deployments during vehicle driving experiences. The MR technologies provide augmented and virtual reality experiences to one or more users (e.g., drivers and/or passengers) of an ego vehicle 101 to enhance situational awareness and entertainment during driving. The data transmission allows a real-time information flow to deliver information to the users in a timely and effective manner. Particularly, the multimodal offloading system 100 may capture an image or a frame 401 of environment 105 surrounding the ego vehicle 101 and transfer the image or the frame 401 to an edge server 301 for task performance via wireless communication 250. The multimodal offloading system 100 may receive data transmitted from the edge server 301 and further integrate the received data into the MR function deployments.

The multimodal offloading system 100 may include one or more reality devices 201. The reality devices 201 are the local devices and components used by a user for the MR experience, such as while driving an autonomous vehicle. In some embodiments, the reality devices 201 may perform any MR-related functions to interact with the user to provide an immersive MR experience, such as immersive navigation, object detections, and ad recommendations, without any assistance from external devices or cloud-based services. In some embodiments, the reality devices 201 may collaborate with external devices and services, such as the wireless communication 250 and the edge server 301, to enhance the MR experience for the user when local devices may be insufficient to perform the desirable tasks or provide desirable information.

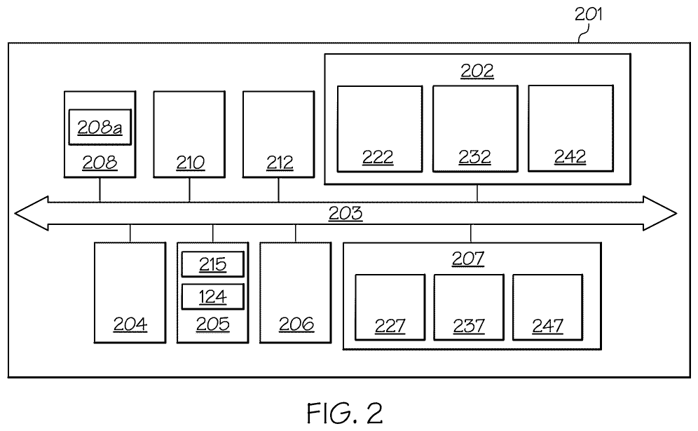

In some embodiments, the reality devices 201 may include, without limitation, a virtual head unit 120, a computation offloading module 222, one or more sensors, such as a vision sensor 208, an eye-tracking sensor 208a, and a head-tracking sensor 210, a rendering device 124, a sound sensor 212, or a combination thereof. The eye-tracking sensor 208a may capture information regarding the user's eyes, such as user eye movements. The vision sensor 208 may operably capture environmental images or videos in consequence of one or more frames 401 of environment 105 around the user and/or the ego vehicle 101. The reality devices 201 may further include the network interface hardware 206 (e.g., as illustrated in FIG. 2) that can be communicatively coupled to a wireless communication 250 to transmit data to and/or from external computing resources, such as the edge server 301.

In some embodiments, the virtual head unit 120 may include, without limitation, the vision sensor 208, glasses 122, the eye-tracking sensor 208a, the head-tracking sensor 210, and the rendering device 124. The eye-tracking sensor 208a may operably track the user's eye movements, such as, without limitation, positions, angles, or pupil sizes of the one or more eyes of the user. The eye-tracking sensor 208a may enable the multimodal offloading system 100 to understand where the user is looking for gaze-based interaction with virtual objects, adjust the level of operation of the system to improve performance and reduce computational load, and analyze the user's attention and interest. The head-tracking sensors 210 may track the user's head movement. The head-tracking sensor 210 may allow the multimodal offloading system 100 to understand the position and orientation of the user's head in physical space. The rendering devices 124, such as one or more projectors, may superimpose images or texts onto the user's eyes or an immersive screen, such as a see-through display or the glasses 122, to render the images or texts into the real-world view of the user.

In some embodiments, the vision sensor 208 may be operable to acquire image and video data, such as one or more frames 401, of the environment 105 surrounding the reality devices 201. The vision sensor 208 may include the eye-tracking sensor 208a operable to acquire images and video data of the user's eyes. The vision sensor 208 may be, without limitation, an RGB camera, a depth camera, an infrared camera, a wide-angle camera, an infrared laser camera, or a stereoscopic camera. The vision sensor 208 may be equipped, without limitation, on a smartphone, a tablet, a computer, a laptop, the virtual head unit 120, or on the ego vehicle 101. In operation, the vision sensor 208 may continuously capture one or more frames 401 of the environment 105 surrounding the reality devices 201 or the ego vehicle 101.

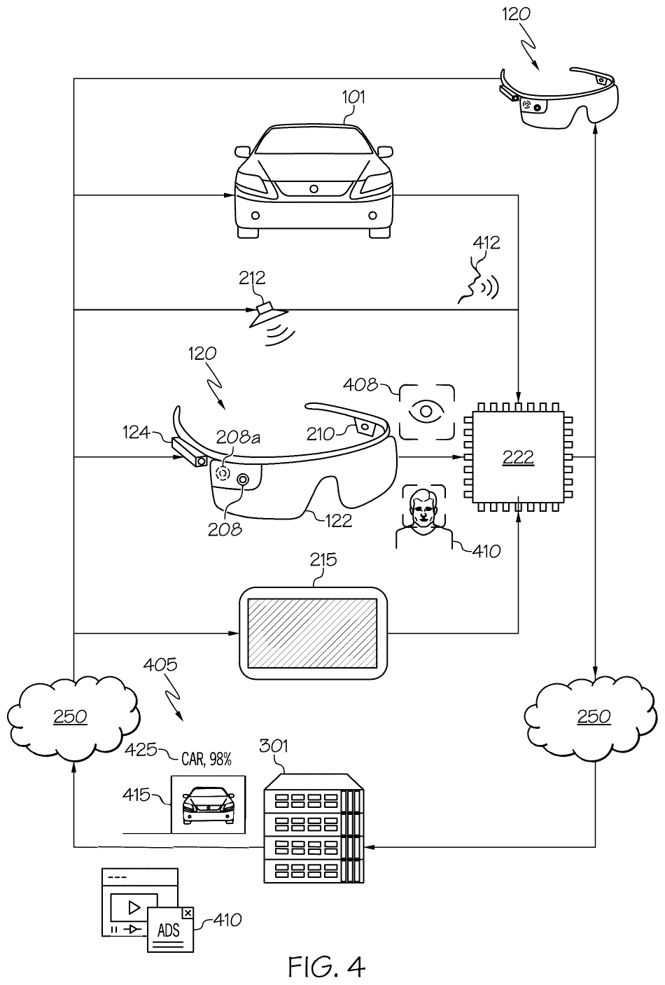

In some embodiments, the multimodal offloading system 100 may include a display 215 (e.g., in FIGS. 2 and 4). The display 215 may be equipped, without limitation, on the ego vehicle 101, a touchscreen, a smartphone, a tablet, a computer, a laptop, or the virtual head unit 120. The display 215 may display any information, media, video, images, or user interaction interfaces related to the operation of the vehicle and/or entertainment activities. The display 215 may be used as an external device collaborating with the use of the virtual head unit 120. For example, the display 215 may display the frame 401 captured by the vision sensor 208 may be processed with additional information implanted, e.g., detected objects with related information. The user may further interact with the display 215, such as touching or via a touchpad to perform vehicle operations, such as route planning, and/or entertainment activities, such as immersion in a video or a game.

In some embodiments, the multimodal offloading system 100 may include an interaction device. The interaction device may provide communication between the user and the virtual world. The interaction device may include a tangible object, such as, without limitation, a marker, a physical model, a sensor, a wearable motion-tracking device, or a smartphone.

In some embodiments, the multimodal offloading system 100 may include a sound sensor 212. The sound sensor 212 may operably determine the volume, pitch, frequency, and/or features of sounds in the ego vehicle 101 or around the virtual head unit 120. The sound sensor 212 may be embedded in the virtual head unit 120 or inside the ego vehicle 101 to detect and process the sound waves that are produced when the user or a passenger speaks in the ego vehicle 101. The multimodal offloading system 100 may include a speech processor to convert the sound waves into human language and further recognize the meaning within, such as user commands.

In some embodiments, the vision sensor 208, the eye-tracking sensor 208a, the head-tracking sensor 210, and the rendering device 124 may be included in the ego vehicle 101. For example, the vision sensor 208, the eye-tracking sensor 208a, the head-tracking sensor 210, or the rendering device 124 may be mounted on a windshield, a steering wheel, a dashboard, or a rearview mirror of the ego vehicle 101.

In some embodiments, the computation offloading module 222 may include one or more processors communicately coupled to other reality devices. The computation offloading module 222 may receive data generated by one or more other reality devices 201, such as the image or video data generated by the vision sensor 208 and the eye-tracking sensor 208a, the sound data generated by the sound sensor 212, and the motion data generated by the head-tracking sensor 210. The computation offloading module 222 may further inquire and receive information on external hardware and devices, such as the wireless communication 250 and the edge server 301. The computation offloading module 222 may determine whether to transmit the real-time frames 401 to the edge server 301.

In some embodiments, the computation offloading module 222 may include an artificial intelligence (AI) module including one or more AI algorithms. The AI module may be used to monitor the user head movement, the user eye tracking, and the user commands. The AI module may include a deep reinforcement learning function. The deep reinforcement learning function may include determining whether to offload one or more tasks to the edge server 301, based on the eye-tracking data, the head-tracking data, the voice commands, driving statistics of the user, or a combination thereof. The AI algorithms may be trained based on the rewards of correct computation offloading determination that meets the user's demands, reduced bandwidth, and penalty for incorrect computation offloading determination and delayed task performance.

The multimodal offloading system 100 may include one or more processors (e.g., as illustrated in FIG. 2). The processors may be included, without limitation, in a controller (such as a computer, a laptop, a tablet, or a smartphone), the virtual head unit 120, a server, or a third-party electronic device.

The multimodal offloading system 100 may include the ego vehicles 101. In embodiments, each of the ego vehicles 101 may be an automobile or any other passenger or non-passenger vehicle such as, for example, a terrestrial, aquatic, and/or airborne vehicle. Each of the ego vehicle 101 may be an autonomous vehicle that navigates its environment with limited human input or without human input. Each of the ego vehicle 101 may drive on a road 115, where one or more non-ego vehicles 103 may share the road 115 with the ego vehicle 101. Each of the vehicles 101 and 103 may include actuators for driving the vehicle, such as a motor, an engine, or any other powertrain. The vehicles 101 and 103 may move or appear on various surfaces, such as, without limitation, roads, highways, streets, expressways, bridges, tunnels, parking lots, garages, off-road trails, railroads, or any surfaces where the vehicles may operate.

In embodiments, the vision sensors 208 may continuously capture frames of environment 105 surrounding the user and the ego vehicle 101, such as a non-ego vehicles 103 near the ego vehicle 101, objects in the environment 105 surrounding the ego vehicle, such as buildings, traffic lights, places of interests, contextual information, such as weather information, a type of the road on which the ego vehicle 101 is driving, a surface condition of the road 115 on which the ego vehicle 101 is driving, and a degree of traffic on the road 115 on which the ego vehicle 101 is driving. The environmental data may include buildings and constructions near the road 115, weather conditions (e.g., sunny, rain, snow, or fog), road conditions (e.g., dry, wet, or icy road surfaces), traffic conditions, road infrastructure, obstacles (e.g., non-ego vehicles 103 or pedestrians), lighting conditions, geographical features of the road 115, and other environmental conditions related to driving on the road 115.

In embodiments, the reality devices 201 and/or the ego vehicle 101 may send a calculation offloading request, one or more computation tasks, such as object detection in the real-time frame 401 or a cropped frame based on the real-time frame 401, to the edge server 301. The reality devices 201 and/or the ego vehicle 101 may include a network interface hardware 206 and communicate with the edge server 301 via wireless communications 250. The reality devices 201 and/or ego vehicle 101 may transmit, without limitation, the frame 401 or the cropped frame, environmental data, sensory data, real-time driver reaction time, user driving statistics associated with the user, a user profile, entertainment data, or a combination thereof. In some embodiments, the ego vehicle 101 may communicate with the edge server 301 using a smartphone, a computer, a tablet, or a digital device that requires data processing.

In embodiments, the edge server 301 may be any networked computing device strategically positioned at the periphery of a centralized network, providing localized data processing and storage to reduce latency and enhance real-time interaction capabilities. For example, the edge server 301 may include, without limitation, one or more of cloud servers, smartphones, tablets, telematics servers, fleet management servers, connected car platforms, application servers, Internet of Things (IoTs) servers, or any server with the capability to transmit data with the reality devices 201. The edge server 301 may work with the reality device 201 and/or the ego vehicle to enable efficient offloading of computationally intensive tasks, such as video and image processing. The edge server 301 may include high-performance central processing units (CPUs), graphic processing units (GPUs), memory storage, and specialized AI accelerators, allowing it to perform rapid analysis, rendering, and decision-making processes. In interaction with the ego vehicle 101 and/or the reality devices 201, the edge server 301 may receive raw data streams, process these streams to extract relevant information and transmit processed data or actionable insights back to the connected device. Additionally, the edge server 301 may manage other tasks, including data filtering, compression, and local storage, offloading the ego vehicle 101 or the reality devices 201, and optimizing overall system performance. The edge server 301 may include server network interface hardware 306 and communicate with the reality devices 201, the ego vehicles 101, and other servers via wireless communications 250. The edge server 301 may include an object detection module 322 operable to analyze uploaded images and video frames to identify any objects of interest within and generate object detection data to send back to the reality devices 201 and/or the ego vehicle 101.

The wireless communication 250 may connect various components, the reality devices 201, the ego vehicle 101, and the edge server 301 of the multimodal offloading system 100, and allow signal transmission between the various components, the reality devices 201, the ego vehicles, and/or the edge server 301 of the multimodal offloading system 100. In one embodiment, the wireless communications 250 may include one or more computer networks (e.g., a personal area network, a local area network, or a wide area network), cellular networks, satellite networks, a global positioning system, and combinations thereof. Accordingly, the reality devices 201, the ego vehicles 101, and the edge servers 301 can be communicatively coupled to the wireless communications 250 via a wide area network, a local area network, a personal area network, a cellular network, or a satellite network, etc. Suitable local area networks may include wired Ethernet and/or wireless technologies such as Wi-Fi. Suitable personal area networks may include wireless technologies such as IrDA, Bluetooth®, Wireless USB, Z-Wave, ZigBee, and/or other near-field communication protocols. Suitable cellular networks include, but are not limited to, technologies such as LTE, WiMAX, UMTS, CDMA, and GSM.

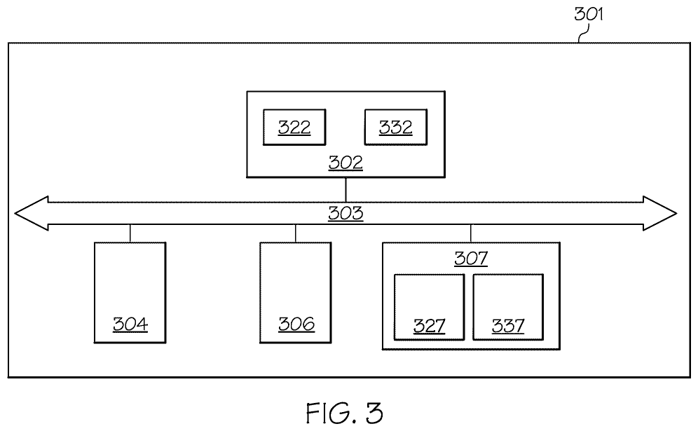

FIGS. 2 and 3 schematically depict example components of the multimodal offloading system 100. The multimodal offloading system 100 may include the one or more reality devices 201, the ego vehicle 101, and/or the edge server 301. While FIG. 2 depicts one reality device 201, more than one reality devices 201 may be included in the multimodal offloading system 100.

Referring to FIG. 2, the reality device 201 may include one or more processors 204. Each of the one or more processors 204 may be any device capable of executing machine-readable and executable instructions. The instructions may be in the form of a machine-readable instruction set stored in data storage component 207 and/or the memory component 202. Accordingly, each of the one or more processors 204 may be a controller, an integrated circuit, a microchip, a computer, or any other computing device. The one or more processors 204 are coupled to a communication path 203 that provides signal interconnectivity between various modules of the system. Accordingly, the communication path 203 may communicatively couple any number of processors 204 with one another, and allow the modules coupled to the communication path 203 to operate in a distributed computing environment. Specifically, each of the modules may operate as a node that may send and/or receive data. As used herein, the term “communicatively coupled” means that coupled components are capable of exchanging data signals with one another such as, for example, electrical signals via a conductive medium, electromagnetic signals via air, optical signals via optical waveguides, and the like.

Accordingly, the communication path 203 may be formed from any medium that is capable of transmitting a signal such as, for example, conductive wires, conductive traces, optical waveguides, or the like. In some embodiments, the communication path 203 may facilitate the transmission of wireless signals, such as WiFi, Bluetooth®, Near Field Communication (NFC), and the like. Moreover, the communication path 203 may be formed from a combination of mediums capable of transmitting signals. In one embodiment, the communication path 203 comprises a combination of conductive traces, conductive wires, connectors, and buses that cooperate to permit the transmission of electrical data signals to components such as processors, memories, sensors, input devices, output devices, and communication devices. Accordingly, the communication path 203 may comprise a vehicle bus, such as for example a LIN bus, a CAN bus, a VAN bus, and the like. Additionally, it is noted that the term “signal” means a waveform (e.g., electrical, optical, magnetic, mechanical, or electromagnetic), such as DC, AC, sinusoidal wave, triangular wave, square-wave, vibration, and the like, capable of traveling through a medium.

The one or more memory components 202 may be coupled to the communication path 203. The one or more memory components 202 may comprise RAM, ROM, flash memories, hard drives, or any device capable of storing machine-readable and executable instructions such that the machine-readable and executable instructions can be accessed by the one or more processors 204. The machine-readable and executable instructions may comprise one or more logic or algorithms written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine-readable and executable instructions and stored on the one or more memory components 202. Alternatively, the machine-readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The one or more processor 204 along with the one or more memory components 202 may operate as a controller or an electronic control unit (ECU) for the reality devices 201 and/or the ego vehicle 101.

The one or more memory components 202 may include the computation offloading module 222, a user command module 232, and an eye/head tracking module 242. The data storage component 207 stores historical eye/head tracking data 237, historical frame/object data 227, and historical user interaction data 247. The historical user interaction data 247 may include, without limitation, historical user driving data, historical user attention data, historical user voice command data, and historical user driving data.

The reality devices 201 may include the input/output hardware 205, such as, without limitation, a monitor, keyboard, mouse, printer, camera, microphone, speaker, and/or other device for receiving, sending, and/or presenting data. The input/output hardware 205 may be coupled to the communication path 203 and communicatively coupled to the processor 204. The input/output hardware 205 may include a display 215, such as, without limitation, a touchscreen, a computer, a laptop, a cell phone, a smartphone, a tablet, a wearable device such as a smartwatch or fitness tracker, and the like. The input/output hardware 205 may include the rendering device 124. The rendering devices 124 is coupled to the communication path 203 and communicatively coupled to the one or more processors 204. The rendering device 124 may include, without limitation, a projector or a display. In some embodiments, the rendering device 124 may display digital content directly onto physical surfaces, such as the glass 122. For example, the rendering device may overlay navigation instructions onto the glass 122 or the road 115 while driving or display additional information regarding objects in the environment 105. In some embodiments, the rendering device 124 may project images directly onto the user's retina to create a blend of virtual and real-world visuals.

The reality device 201 may include network interface hardware 206 for communicatively coupling the reality device 201 to the edge server 301. The network interface hardware 206 can be communicatively coupled to the communication path 203 and can be any device capable of transmitting and/or receiving data via a network. Accordingly, the network interface hardware 206 can include a communication transceiver for sending and/or receiving any wired or wireless communication. For example, the network interface hardware 206 may include an antenna, a modem, LAN port, WiFi card, WiMAX card, mobile communications hardware, near-field communication hardware, satellite communication hardware and/or any wired or wireless hardware for communicating with other networks and/or devices. In one embodiment, the network interface hardware 206 includes hardware configured to operate in accordance with the Bluetooth® wireless communication protocol. The network interface hardware 206 of the reality devices 201 and/or the ego vehicle 101 may transmit its data to the edge server 301 via the wireless communication 250. For example, the network interface hardware 206 of the reality devices 201 and/or the ego vehicle 101 may transmit the frame 401 and other task related data to the edge server 301, and receive processed information, task performance results, and any relevant data, such as, without limitation, vehicle data, image and video data, object detection data, and the like from the edge server 301.

In some embodiments, the vision sensor 208 is coupled to the communication path 203 and communicatively coupled to the processor 204. The reality device 201 and/or the ego vehicle 101 may include one or more vision sensors 208. The vision sensors 208 may be used for capturing images or videos of the environment 105 around the user and/or the ego vehicles 101. In some embodiments, the one or more vision sensors 208 may include one or more imaging sensors configured to operate in the visual and/or infrared spectrum to sense visual and/or infrared light. Additionally, while the particular embodiments described herein are described with respect to hardware for sensing light in the visual and/or infrared spectrum, it is to be understood that other types of sensors are contemplated. For example, the systems described herein could include one or more LIDAR sensors, radar sensors, sonar sensors, or other types of sensors for gathering data that could be integrated into or supplement the data collection described herein. Ranging sensors like radar may be used to obtain rough depth and speed information for the view of the reality devices 201 and/or the ego vehicle 101. The one or more vision sensors 208 may include a forward-facing camera installed in the reality devices 201 and/or the ego vehicle 101. The one or more vision sensors 208 may be any device having an array of sensing devices capable of detecting radiation in an ultraviolet wavelength band, a visible light wavelength band, or an infrared wavelength band. The one or more vision sensors 208 may have any resolution. In some embodiments, one or more optical components, such as a mirror, fish-eye lens, or any other type of lens may be optically coupled to the one or more vision sensors 208. In embodiments described herein, the one or more vision sensors 208 may provide image data to the one or more processors 204 or another component communicatively coupled to the communication path 203. In some embodiments, the one or more vision sensors 208 may also provide navigation support. That is, data captured by the one or more vision sensors 208 may be used to autonomously or semi-autonomously navigate a vehicle.

In some embodiments, the vision sensors 208 may include the eye-tracking sensor 208a. The eye-tracking sensor 208a may be operable to track the movements of the one or more eyes of the user and generate the eye-tracking data. The eye-tracking data may include user focus points, gaze fixations of each corresponding focus point, saccades between gaze fixations, scan paths of gaze fixations and saccades, and pupil dilation. The eye-tracking sensor 208a may be a remote eye-tracking sensor positioned at a distance to track the user's eye movements without needing physical contact with the user, and/or a head-mounted eye-tracking sensor equipped on the virtual head unit 120 or a place inside the ego vehicle 101 that directly tracks eye movements. The eye-tracking sensor 208a may be an infrared-based eye-tracker that uses infrared light to detect the reflection from the retina and cornea to calculate the point of gaze. For example, the eye-tracking sensor may include an infrared laser source operable to illuminate the user eyes and an eye camera operable to capture the eye-tracking data. The eye-tracking sensor 208a may be a video-based eye-tracker that uses high-speed cameras to capture eye movements to determine gaze direction. The eye-tracking sensor 208a may be an electrooculography that measures the electrical potential around the user's eyes to infer movement and position.

In some embodiments, the head-tracking sensor 210 is coupled to the communication path 203 and communicatively coupled to the processor 204. The head-tracking sensor 210 may include an inertial sensor, an optical sensor, a magnetic sensor, an acoustic sensor, or a combination thereof. The head-tracking sensor 210 may operably monitor and measure the position and movement of the user's head. For example, in one embodiment, the head-tracking sensor 210 may include accelerometers and/or gyroscopes in the virtual head unit 120 to monitor the user's head movements. In another embodiment, the head-tracking sensor 210 may be a camera attached to the ego vehicle 101 to track the position and movement of the user's head.

In some embodiments, the sound sensor 212 is coupled to the communication path 203 and communicatively coupled to the processor 204. The sound sensor 212 may be one or more sensors coupled to the multimodal offloading system 100 for determining the volume, pitch, frequency, and/or features of sounds in the ego vehicle 101 or around the virtual head unit 120. The sound sensor 212 may include a microphone or an array of microphones that may include mechanisms to filter background noise, such as engine sounds or beamforming. The sound sensor 212 may be embedded in the virtual head unit 120 or inside the ego vehicle 101 to detect and process the sound waves that are produced when a person speaks in the vehicle. For example, the sound sensor 212 may be located in the ceiling, dashboard, or center console of the ego vehicle 101. The sound sensor 212 may be connected to one or more microphones picking up the soundwaves. The soundwaves may be then processed by the multimodal offloading system 100 which converts the soundwaves into digital signals.

Referring to FIG. 3, the edge server 301 includes one or more processors 304, one or more memory components 302, data storage component 307, server network interface hardware 306, and a local interface 303. The one or more processors 304 may be a controller, an integrated circuit, a microchip, a computer, or any other computing device. The one or more memory components 302 may comprise RAM, ROM, flash memories, hard drives, or any device capable of storing machine-readable and executable instructions such that the machine-readable and executable instructions can be accessed by the one or more processors 304. The one or more memory components 302 may include an object detection module 322 and an task performance module 332. The data storage component 307 may store historical task performance data 327, and historical user preference data 337.

In some embodiments, the object detection module 322 may, after receiving an object detection task request and the frame 401 or the cropped frame from the reality devices 201 or the ego vehicle 101, normalize, resize, and adjust the received selected frames, use one or more object detection models, such as You Only Look Once (YOLO), Single Shot Multbox Detector (SSD), Region-based Convolutional Neural Networks (R-CNN) to generated model outputs, such as, without limitation, bounding boxes (e.g., coordinates of rectangles around detected objects), class labels (e.g., type of the object), and confidence scores for each detected object. In some embodiments, the object detection module 322 may further conduct non-maximum suppression to eliminate redundant overlapping boxes and apply a confidence score threshold to filter out low-confidence detections. The generated detection data, such as [{“Boxes”: [coordinate point 1, coordinate point 2, coordinate point 3, coordinate point 4], “Confidence”: [a value between 0 and 1], “Classes”: “object type”}], for each detected object, may be sent to the reality devices 201and/or the ego vehicle 101. The object detection and detection data transmission may consider other factors, such as the user's preference and past object detection.

In some embodiments, the task performance module 332 may perform calculation tasks sent from the reality devices 201. For example, the edge server 301 may receive a calculation task of video or ad recommendation. The task performance module 332 may determine what video and/or ad to recommend based on the received frame 401, detected objects in the frame 401, time/date, location of the reality device 201 and/or the ego vehicle 101, the historical task performance data 327, the historical user preference data, or a combination thereof.

Referring back to FIGS. 2 and 3, each of the reality device modules and the server modules, such as the computation offloading module 222, the user command module 232, the eye/head tracking module 242, the object detection module 322, and the task performance module 332, may include one or more machine learning algorithms. The reality device modules and the server modules may be trained and provided with machine-learning capabilities via a neural network as described herein. By way of example, and not as a limitation, the neural network may utilize one or more artificial neural networks (ANNs). In ANNs, connections between nodes may form a directed acyclic graph (DAG). ANNs may include node inputs, one or more hidden activation layers, and node outputs, and may be utilized with activation functions in the one or more hidden activation layers such as a linear function, a step function, logistic (Sigmoid) function, a tanh function, a rectified linear unit (ReLu) function, or combinations thereof. ANNs are trained by applying such activation functions to training data sets to determine an optimized solution from adjustable weights and biases applied to nodes within the hidden activation layers to generate one or more outputs as the optimized solution with a minimized error. In ML applications, new inputs may be provided (such as the generated one or more outputs) to the ANN model as training data to continue to improve accuracy and minimize error of the ANN model. The one or more ANN models may utilize one-to-one, one-to-many, many-to-one, and/or many-to-many (e.g., sequence-to-sequence) sequence modeling. The one or more ANN models may employ a combination of artificial intelligence techniques, such as, but not limited to, Deep Reinforcement Learning (DRL), Random Forest Classifiers, Feature extraction from audio, images, clustering algorithms, or combinations thereof. In some embodiments, a convolutional neural network (CNN) may be utilized. For example, a convolutional neural network (CNN) may be used as an ANN that, in the field of machine learning, for example, is a class of deep, feed-forward ANNs applied for audio analysis of the recordings. CNNs may be shift or space-invariant and utilize shared-weight architecture and translation. Further, each of the various modules may include a generative artificial intelligence algorithm. The generative artificial intelligence algorithm may include a general adversarial network (GAN) that has two networks, a generator model and a discriminator model. The generative artificial intelligence algorithm may also be based on variation autoencoder (VAE) or transformer-based models.

Referring to FIG. 4, the multimodal offloading system 100 for reducing latency and bandwidth usage is depicted. The multimodal offloading system 100 may include the reality device 201, including, without limitation, the vision sensor 208, the eye-tracking sensor 208a, the head-tracking sensor 210, and the sound sensor 212. In some embodiments, the computation offloading module 222 may determine a level of computation offloading to an edge server based on the behavior data, such as the head movement data 410, the eye-tracking data 408, and the voice commands 412. The reality device 201 may offload one or more tasks to the edge server based on the level of computation offloading.

In some embodiments, in operation, the user may wear the one or more reality devices 201, such as the virtual head unit 120 while using or driving the ego vehicle 101. The vision sensor 208 on the virtual head unit 120 or the ego vehicle 101 may continuously capture images and/or image frames 401 of the environment 105 around the user and/or the ego vehicle 101. The user may operate the ego vehicle 101, such as performing route planning, using the virtual head unit 120, while the virtual head unit 120 may analyze the environment 105 surrounding the user, such as location, lighting conditions, and nearby objects, and perform object detections that may interest the user, and further recommend relevant recommendations, such as relevant information, ads, videos, and the like. The reality device 201 may track the user's behaviors, e.g., the gaze direction, facial expressions, and gestures to infer user's interests and preferences. This data can be used to refine the object detection, information and media recommendations.

In some embodiments, the computation offloading module 222 may determine whether to transfer any captured frames 401 to the edge server 301 for image processing tasks, such as object detection, considering the local computing resources and efficiency, and the remote devices and network resources and efficiency. For example, the computation offloading module 222 may crop the frame 401 based on the user eye-tracking data and head-tracking data. The reality devices 201 may collect the eye-tracking data and the head-tracking data using the eye-tracking sensor 208a and the head-tracking sensor 210. The vision sensor 208 may work with the eye/head tracking module 242 and the user command module 232 to determine the states of the generated video frames and focus area. The eye/head tracking module 242 may utilize eye-tracking data from the eye-tracking sensor 208a and head-tracking data from the head-tracking sensor 210 to assess the user's focus area in the current frame and the interest in objects within the current frame. The eye/head tracking module 242 may determine whether the interested virtual object exists in the frame based on the eye movements, such as, without limitation, positions, angles, or pupil sizes of the one or more eyes of the user. The eye/head tracking module 242 may estimate the level of interest by analyzing eye movement patterns such as, without limitation, user focus points, gaze fixations of each corresponding focus point, saccades between gaze fixations, scan paths of gaze fixations and saccades, pupil dilation fixation, skipping, regression, alongside head orientation, head movements, and head stability.

In some embodiments, the computation offloading module 222 may determine whether there is any interested virtual object in the frame 401 based on the user's gaze-based interaction with virtual objects. The gaze-based interaction may include duration and frequency of gaze frequency to the virtual objects. For example, the eye/head tracking module 242 may determine the existence of interested virtual object in the current frame based on first fixation time and duration, number of fixations, number of visits, and total time spent.

In some embodiments, the user command module 232 may include a large language module or a natural language module to identify the user commands based on the sound data collected by the sound sensor 212. The user command module 232 may identify the user command as, for example, a start-offload command, a pause-offload command, a resume-offload command, or the like. The computation offloading module 222 may stop computation offload when the user command is the start-offload command, such as “Stop Edge Computing.” The computation offloading module 222 may temporarily pause computation offloading for a short period of time, such as one or two seconds, when the user command is the pause-offload command, such as “Pause Edge Computing for a second.” The computation offloading module 222 may resume the computation offloading when the user command is the resume-offload command, such as “Resume Edge Computing.”

In embodiments, the computation offloading module 222 may determine a computing resource level for each task based on the local resource availability, bandwidth, latency requirements, and the behavior data, such as the head movement data, eye-tracking data, and voice commands of the user. The computation may offload, to the edge server 301, the tasks having corresponding computing resource levels greater than a resource threshold level. The resource threshold level may be a predefined benchmark that helps in deciding whether a task should be executed locally on the reality device 201 or offloaded to the edge server 301. The computation offloading module 222 may calculate the resource requirements for a task based on current conditions and user data (e.g., head movement, eye-tracking, voice commands) and compare these measurements against the threshold values. In some embodiments, the resource threshold level may be determined based on benchmarking tests given the capability limits of the reality device 201 and user feedback. In some embodiments, the resource threshold level may be set by the user, such as, high, moderate, or low. For example, the computation offloading module 222 may determine that an object detection task in the current frame 401 may require high CPU usage, high memory usage, but the bandwidth requirement is low and the latency is low, such that the computing resource level is high. Further, the user may stare at the scene suggesting the user is interested in at least one object in the frame 401. The user may provide a user command to allow edge computing. The resource threshold level may be set as moderate. Accordingly, the computation offloading module 222 may then offload the task to the edge server 301.

In embodiments, the reality devices 201 and/or the ego vehicle 101 may transmit the frame 401 and one or more task requests to the edge server 301 through the wireless communications 250. The edge server 301 may feed the object detection module 322 with the task requirement in the objection detection task request and the frame 401, and feed the tasks, such as ads recommendation, lane detection, localization and mapping, path planning, to the task performance module 332 to perform relevant computations. The object detection module 322 may perform the object detection using one or more object detection models, such as, without limitation, You Only Look Once (YOLO), Single Shot Multbox Detector (SSD), Region-based Convolutional Neural Networks (R-CNN) to detect the objects within the frame 401. In some embodiments, the object detection module 322 may personalize the object detection based on the request information, such as the user's preference, and past object detection, such as historical user preference data 337. In some embodiments, the object detection module 322 may further conduct non-maximum suppression to eliminate redundant overlapping boxes and apply a confidence score threshold to filter out low-confidence detections. The object detection module 322 may generate object outputs 405. The object output 405, such as, without limitation, box cords 415 (e.g., coordinates of polygons around detected objects in the frame 401) and object information 425, such as class labels (e.g., type of the object), and confidence scores (a value between 0 and 1) for each detected object. For example, an object output may include detection data associated with an identified object, such as [{“Boxes”: [coordinate point 1, coordinate point 2, coordinate point 3, coordinate point 4], “Confidence”: [a value between 0 and 1], “Classes”: “object type”}]. In some embodiments, some of the object output 405 can be integrated into the frame 401, such as the box cords 415 and the object information 425. Each box cord 415 may include coordinates of three or more vertices of the corresponding detected object. For example, as illustrated in FIG. 4, the detected object has a class of “CAR.” The confidence value of 98% suggests a high confidence of the detected object as a car at the corresponding box cord.

In some embodiments, upon object detection, the edge server 301 may further retrieve the object information 425 related to the detected objects from the object information data 347, other databases, or the Internet. The retrieved object information 425 may be included in the object outputs 405 to be sent to the reality devices 201 and/or the ego vehicle 101. For example, in one embodiment, the edge server 301 may recognize the object as a building that may be of interest to the user based on the user reference data. The edge server 301 may then retrieve relevant data of the building to be included in the object outputs associated with the building. In another embodiment, the edge server 301 may recognize the object as a vehicle with a plate number. The edge server 301 may search the plate number from a vehicle database and retrieve public information regarding the driver of the vehicle, such as, whether the driver has any traffic violations, and further to determine whether to include a warning in the object output associated with the vehicle.

Still referring to FIG. 4, in some embodiments, the task performance module 332 may generate one or more recommended videos and/or ads. The recommended videos and/or ads may be generated based on the historical task performance data 327, the detected objects in the frame 401, current time/date, a location of the ego vehicle 101, or a combination thereof. The edge server 301 may then send the object detection data and/or the recommendation data to the reality devices 201 and/or the ego vehicle 101 via the wireless communication 250.

In some embodiments, after receiving the object detection data, the reality devices 201 may render the received data from the edge server 301. For example, the reality device 201 may allocate one or more box cords 415 representing each detected object based on the coordinates of the detected objects in a 3D environment. The reality device 201 may include the corresponding class label and confidence score in each box cord 415. The reality device 201 may then superimpose the object detection data onto a real-world view of the user, for example, onto the glasses 122 to blend the information into the user's real-world view in real time. The reality device 201 may further superimpose the recommended ads and/or videos into the real-world view of the user, e.g., around the detected objects relevant to the ads.

In some embodiments, after receiving the object detection data, the ego vehicle 101 may be autonomously driven based on the object detection data. The multimodal offloading system 100 may create a real-time map of the environment 105 and implement a path planning algorithm to determine a desirable route or vehicle operation. The multimodal offloading system 100 may further control the steering, throttle, and braking system of the ego vehicle 101 and monitor the ego vehicle 101

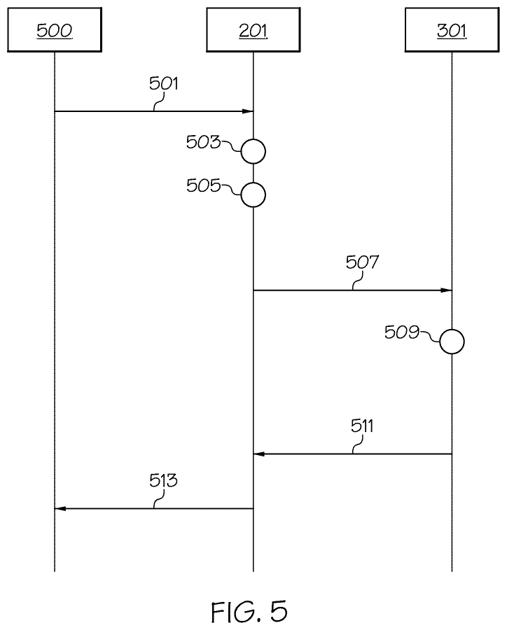

Referring to FIG. 5, a sequence diagram for computation offloading determination using multi-modal user input is depicted. At block 501, a user 500 may wear the reality device 201, such as the virtual head unit 120, while driving the ego vehicle 101. At block 503, the reality device 201 may capture multimodal input data, such as eye movements, head movements, and voice commands of the user 500. For example, the virtual head unit 120 may include the head-tracking sensor 210, the eye-tracking sensor 208a, and the sound sensor 212 to perform movement tracking. At block 505, the reality device 201 may process the multimodal input data and identify patterns to decide whether to send an offload request to the edge server 301 to offload any computation based on the collected multimodal input data. At block 507, the reality device 201 may transmit the offload request associated with task data to the edge server 301 for offload computations. For example, the reality device 201 may decide to offload the object detection computation and transmit the request and frame 401 to the edge server 301. At block 509, the edge server 301 may perform the requested computation. At block 511, the edge server 301 may send computation results (e.g., object detection information) back to the reality device 201 and/or the ego vehicle 101. At block 513, the reality device 201 may integrate the received results into the MR experience for the user 500 (visual, auditory, or haptic), such as rendering an MR environment with real-time object detection to the user 500. In embodiments, the reality devices 201 and the edge server 301 may perform continuous data exchange during user interaction. While FIG. 5 depicts performing object detection tasks, other tasks may be requested by the ego vehicle 101 and/or the reality devices 201, and performed by the edge server 301.

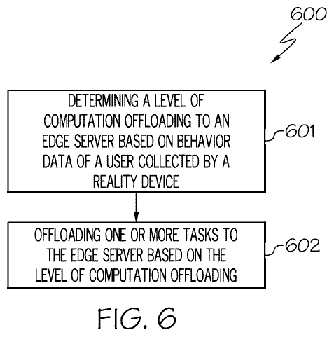

Referring to FIG. 6, a flowchart for illustrative steps for the method 600 for performing computation offloading determination using multi-modal user input of the present disclosure is depicted. At block 601, the present method 600 may include determining a level of computation offloading to the edge server 301 (in FIG. 1) based on behavior data of the user collected by the reality device 201 (in FIG. 1). At block 602, the present method 600 may include offloading one or more tasks to the edge server 301 based on the level of computation offloading. In some embodiments, the behavior data may include head movement data, eye-tracking data, and voice commands. The voice commands may include a start-offload command, a pause-offload command, and a resume-offload command. The head movement data may be collected by the head-tracking sensor 210 (e.g., in FIG. 1). The eye-tracking data may be collected by the eye-tracking sensor 208a (e.g., in FIG. 1). The eye-tracking data may include eye positions of the user, an eye angle of the user, and pupil size of the user. The voice commands may be collected by the sound sensor 212 (e.g., in FIG. 1). The one or more tasks may include object detection, ads recommendation, lane detection, localization and mapping, path planning, or a combination thereof

In some embodiments, the method 600 may further include capturing the frame 401 (e.g., in FIG. 1) of a view external to a vehicle (e.g. the ego vehicle 101 in FIG. 1) using the reality device 201, determining whether an interested virtual object exists in the frame 401 based on the head movement data and the eye-tracking data, and in response to determining that the interested virtual object exists in the frame 401, transmitting the frame 401 to the edge server 301 for object detection. The eye-tracking data may include user gaze directions.

In some embodiments, the method 600 may further include determining a computing resource level for each task and offload to the edge server 301, the tasks having corresponding computing resource levels greater than a resource threshold level.

In some embodiments, the method 600 may further include receiving object detection data from the edge server 301. The received object detection data may include box cords of detected objects in the frame 401 of a view external to the vehicle (e.g., the ego vehicle 101 in FIG. 1) captured by the reality device 201 (e.g., in FIG. 1), confidence of each corresponding box cord, and object information of each detected object.

In some embodiments, the method 600 may further include autonomously driving the vehicle based on the object detection data.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for reducing latency and bandwidth usage in reality devices comprising:
a reality device operably collecting behavior data of a user;
one or more processors operable to:
determine a level of computation offloading to an edge server based on the behavior data; and
offload one or more tasks to the edge server based on the level of computation offloading.

2. The system of claim 1, wherein the behavior data comprises head movement data, eye-tracking data, and voice commands.

3. The system of claim 2, wherein the voice commands comprises a start-offload command, a pause-offload command, and a resume-offload command.

4. The system of claim 2, wherein the one or more processors are further operable to:
capture a frame of a view external to a vehicle using the reality device;
determine whether an interested virtual object exists in the frame based on the head movement data and the eye-tracking data including gaze directions; and
in response to determining that the interested virtual object exists in the frame, transmit the frame to the edge server for object detection.

5. The system of claim 1, wherein the reality device comprises an eye-tracking sensor operable to capture eye-tracking data.

6. The system of claim 5, wherein the eye-tracking data comprises eye positions of the user, an eye angle of the user, and a pupil size of the user.

7. The system of claim 1, wherein the one or more tasks comprise object detection, ads recommendation, lane detection, localization and mapping, path planning, or a combination thereof.

8. The system of claim 7, wherein the one or more processors are further operable to determine a computing resource level for each task and offload, to the edge server, the tasks having corresponding computing resource levels greater than a resource threshold level.

9. The system of claim 1, wherein the one or more processors are further operable to receive object detection data from the edge server, wherein the object detection data comprises box cords of detected objects in a frame of a view external to a vehicle captured by the reality device, confidence of each corresponding box cord, and object information of each detected object.

10. The system of claim 9, wherein the one or more processors are further operable to autonomously drive the vehicle based on the object detection data.

11. The system of claim 9, wherein the one or more processors are further operable to superimpose the object detection data onto a real-world view.

12. A method for reducing latency and bandwidth usage in reality devices comprising:
determining a level of computation offloading to an edge server based on behavior data of a user collected by a reality device; and
offloading one or more tasks to the edge server based on the level of computation offloading.

13. The method of claim 12, wherein the behavior data comprises head movement data, eye-tracking data, and voice commands.

14. The method of claim 13, wherein the voice commands comprises a start-offload command, a pause-offload command, and a resume-offload command.

15. The method of claim 13, wherein the method further comprises:
capturing a frame of a view external to a vehicle using the reality device;
determining whether an interested virtual object exists in the frame based on the head movement data and the eye-tracking data including gaze directions; and
in response to determining that the interested virtual object exists in the frame, transmitting the frame to the edge server for object detection.

16. The method of claim 12, wherein the reality device comprises an eye-tracking sensor operable to capture eye-tracking data, the eye-tracking data comprising eye positions of the user, an eye angle of the user, and a pupil size of the user.

17. The method of claim 12, wherein the one or more tasks comprise object detection, ads recommendation, lane detection, localization and mapping, path planning, or a combination thereof.

18. The method of claim 12, wherein the method further comprises determining a computing resource level for each task and offload to the edge server, the tasks having corresponding computing resource levels greater than a resource threshold level.

19. The method of claim 12, wherein the method further comprises receiving object detection data from the edge server, wherein the object detection data comprises box cords of detected objects in a frame of a view external to the vehicle captured by the reality device, confidence of each corresponding box cord, and object information of each detected object.

20. The method of claim 19, wherein the method further comprises autonomously driving the vehicle based on the object detection data.
